(19) United States
(12) Patent Application Publication
(10) Pub. No.: US 2008/0282477 A1
(43) Pub. Date: Nov. 20, 2008

(54) Press for hot dog and hamburger rolls

(76) Inventor: Michael Thomas Cravatt, Molino, FL (US)

Correspondence Address: Peter Loffler, P.O. Box 1001, Niceville, FL, 32588-1001, US

(21) Appl. No.: 11/804,316

(22) Filed: May 18, 2007

(51) Int. Cl. A21C 3/02; B25F 1/02

(52) U.S. Cl. 7/111; 492/13

(57) ABSTRACT

A press for hot dog rolls and hamburger rolls uses a pair of elongate rollers that are attached to one another by one or more connector legs. One of the rollers serves as a handle while the other is radially rolled across a hot dog roll. A hamburger press is a short plate cylindrical member that has a flat lower surface and an upper surface that is removably attached to one of the rollers. With the opposing roller being used as a handle, the hamburger press is pressed onto a hamburger roll. A patty press is a cylindrical member with a flat bottom and an upwardly depending sidewall that define a hollow central portion. The patty press receives an appropriate food product therein and thereafter the hamburger press is received within the hollow central portion and presses onto the food product in order to form a patty out of the food product.

### BACKGROUND OF THE INVENTION

1. Field of the Invention

The present invention relates to a press that makes indentations into the food receiving surface of a hot dog roll or a hamburger roll so as to allow the rolls to better hold the hot dogs and hamburger patties respectively as well as any condiments. The press also is capable of pressing down on a meat product in order to form a patty.

2. Background of the Prior Art

Nothing says summer better than a warm afternoon, a cool beverage in hand, and the grill cooking up hot dogs and hamburgers. Once the dogs and burgers are hot off the grill, they are slipped into appropriate rolls, piled high with condiments, and thoroughly enjoyed. As delicious as this scenario is, one recurring problem faced by both hot dog and hamburger eaters, is the tendency of the meat product to slip out of the roll, especially if several condiments are loaded onto the hot dog or hamburger. At best, this causes the person to experience an awkward meal with many bites being either of meat, when the meat product has slipped forward, or of bun when the meat product has slipped back. This is not only messy for the person eating the product, it also creates many bites that have a flavor profile that is not that which is desired. At worst, the hot dog or hamburger patty or some of the condiments slips out of their respective bun, making lunch for either Rover or the local ants.

Many eaters attempt to solve this problem by placing a death grip onto the hot dog or hamburger in order to assure that nothing slips out of its baked clothing. While this reduces the incidence of food loss, this method oftentimes causes the condiments to squirt out of the roll and onto the eater or the floor, neither of which is desired. Additionally, a firm grip on the hot dog or hamburger can reduce the respective roll to a flat piece of mush that is unattractive and not particularly satisfying from an appetite point of view.

To address such problems, devices have been proposed that place an indent into the respective roll which indent is sized to receive the hot dog or the hamburger patty or appropriate condiments as desired. However, such devices are designed to be employed at the point of manufacture of the rolls and do not help the average backyard chef who purchases a package or ordinary hot dog rolls or hamburger rolls.

What is needed is a device that allows a consumer, who purchases a standard bag of rolls, either hot dog or hamburger, to be able to make an indent into either of the rolls, which indent is sized to receive the respective meat product for that particular roll. Such an indentation device should be relatively quick and easy to use so that it can be employed anytime hot dogs or hamburgers are served. The device must be of simple design and construction so that it is relatively inexpensive to manufacture so as to be readily affordable to a typical consumer. Ideally, the device can be used to make the appropriate indentations into both hamburger rolls and hot dog rolls.

### SUMMARY OF THE INVENTION

The press for hot dog and hamburger rolls of the present invention address the aforementioned needs in the art by providing a device that allows a consumer of typical hot dog or hamburger rolls to be able to make an indent into the particular roll, which indent is sized to receive the respective meat product for that particular roll. The press for hot dog and hamburger rolls is quick and easy to use, allowing the device to be readily employed anytime hot dogs or hamburgers are served. The press for hot dog and hamburger rolls is of simple design and construction so that it is relatively inexpensive to manufacture, using standard manufacturing techniques, making the device readily affordable to a potential consumer. The press for hot dog and hamburger rolls is capable of making the appropriate indentations into both hamburger rolls and hot dog rolls as well as being able to form patties out of appropriate food products.

The press for hot dog and hamburger rolls of the present invention is comprised of a first elongated cylindrical roller that has a first flattened portion and a second elongated cylindrical roller that has a second flattened portion. One or more connector legs each have a first end attached to the first flattened portion of the first roller and a second end attached to the second flatten portion of the second roller in order to connect the two rollers. The first roller is rolled across a hot dog bun to create a hot dog receiving indentation thereat with the second roller serving as a handle. The first roller and the second roller may be identical. A first press has an upper surface and a flat lower surface such that the upper surface is removably attached to the first roller and the lower surface is pressed onto a hamburger roll to create a hamburger patty receiving indentation thereat. The first press is attached to the first roller by providing a snap clip on the upper surface of the first press such that the snap clip removably receives the first roller. The first press is cylindrical in shape. A second press has a flat bottom and an upwardly depending sidewall defining a hollow central portion such that the hollow central portion receives a meat product, such as hamburger meat, sausage meat, etc., and thereafter receives the first press which presses onto the food product within the hollow central portion in order to form a patty that conforms to the shape of the hollow central portion. The hollow central portion has a shape that is substantially similar to the outer shape of the first press which may but need not necessarily be cylindrical.

### BRIEF DESCRIPTION OF THE DRAWINGS

FIG. 1 is a perspective view of the press for hot dog and hamburger rolls of the present invention illustrating its capabilities for both hot dog and hamburger rolls.

FIG. 2 is a perspective view of the press for hot dog and hamburger rolls making an indentation in a hamburger roll.

FIG. 3 is a perspective view of the press for hot dog and hamburger rolls making an indentation in a hot dog roll.

FIG. 4 is a perspective view of the press for hot dog and hamburger rolls.

FIG. 5 is an exploded view of the hamburger press.

FIG. 6 is a top plan view of the hamburger press.

FIG. 7 is a side elevation view of the hamburger press.

FIG. 8 is a perspective view of the hot dog press.

FIG. 9 is a side elevation view of the hot dog press.

FIG. 10 is a top plan view of the hot dog press.

FIG. 11 is an end view of the hot dog press.

FIG. 12 is a perspective view of the patty press interacting with the remainder of the press for hot dog and hamburger rolls.

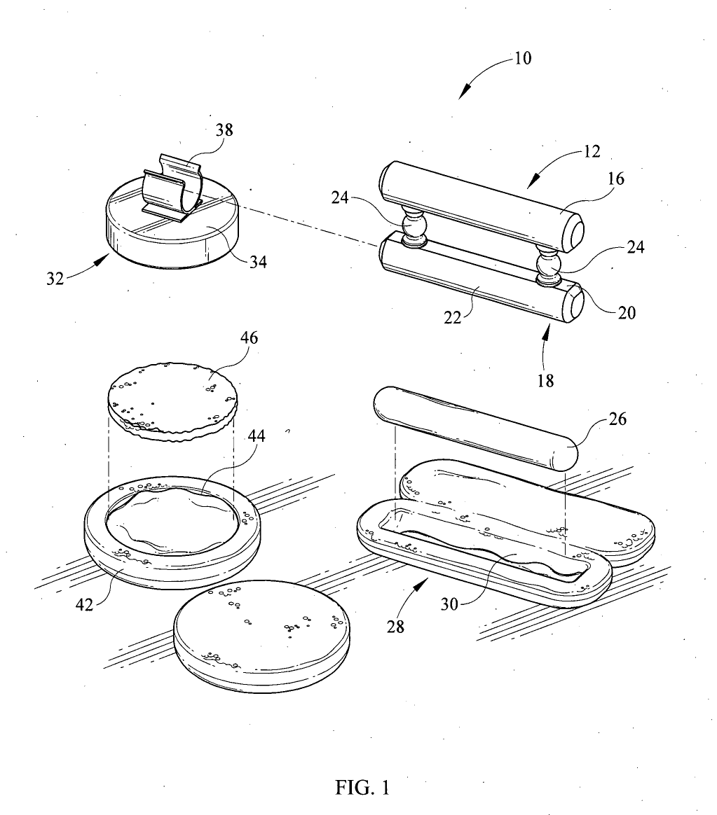

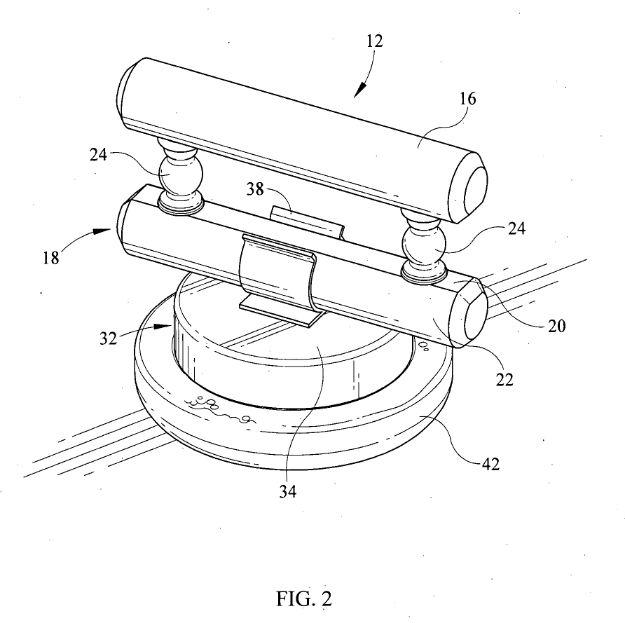

Similar reference numerals refer to similar parts throughout the several views of the drawings.

### DESCRIPTION OF THE PREFERRED EMBODIMENT

Referring now to the drawings, it is seen that the press for hot dog and hamburger rolls, generally denoted by reference numeral 10, is comprised of a first roller 12 which is an elongate cylindrical member having a flat surface 14 and a rounded surface 16. A second roller 18, which is also an elongate cylindrical member, has a flat surface 20 and a rounded surface 22. One or more connector legs 24 join the first roller 12 and the second 18 in spaced apart relation, each connector leg 24 attaching to the flat surface 14 of the first roller 12 and the flat surface 20 of the second roller 18. The first roller 12 and the second roller 18 may, but need not necessarily be, of identical size, shape, and construction. The first roller 12, the second roller 18, and the connector legs 24 may be made from any appropriate material such as wood or plastic. Attachment of each connector leg 24 to the first roller 12 and the second roller 18 is by any appropriate method well known in the art and being material dependent. For example, if each component 12, 18, and 24, is made of wood, then the components can be attached by adhesion, pins or screws (neither illustrated), etc. If each component is made from plastic, then the components can be attached by ultrasonic welding, snap fit connectors (not illustrated), etc. Other materials may utilize other attachment methods as is appropriate for such materials. Of course, the components 12, 18, and 24, can be formed as a single monolithic structure.

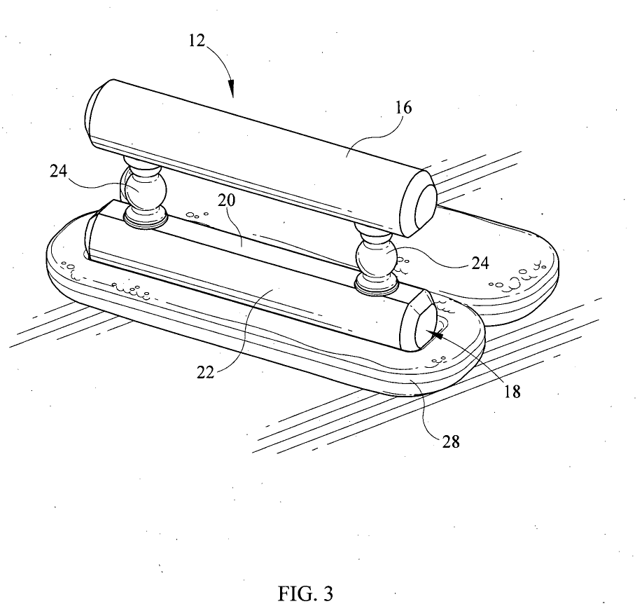

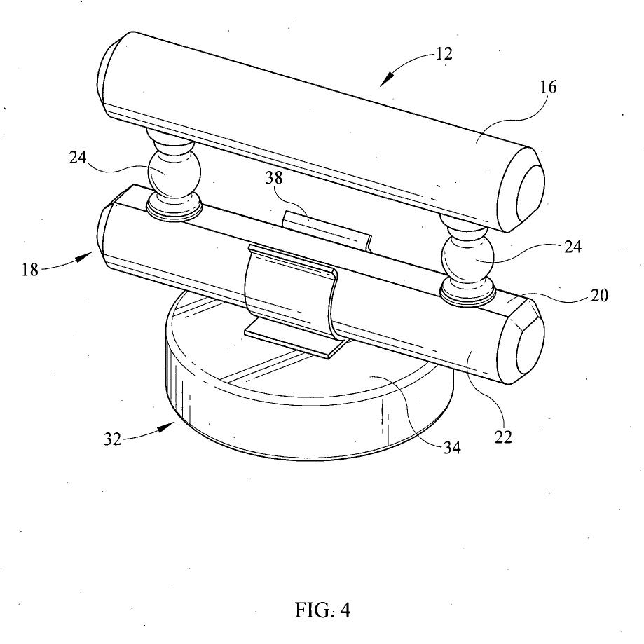

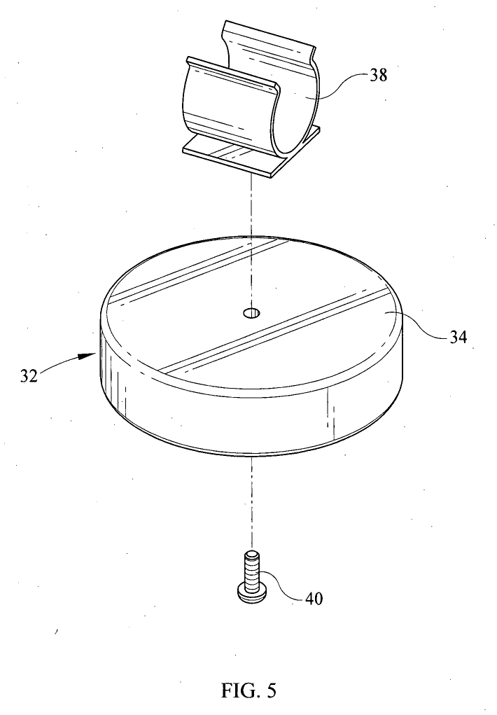

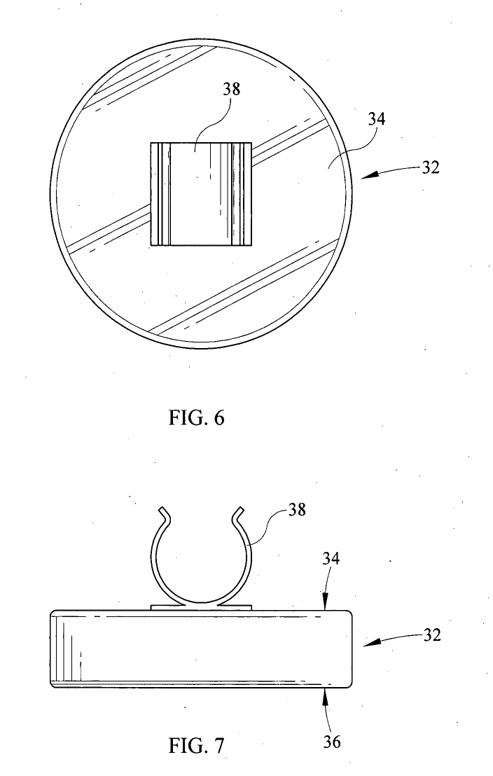

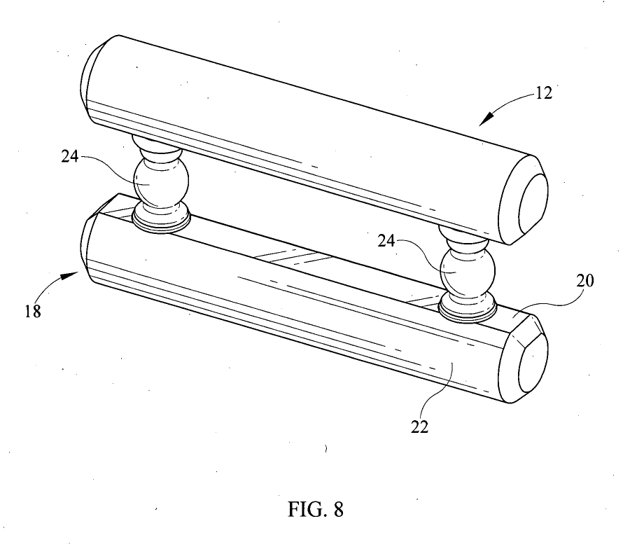

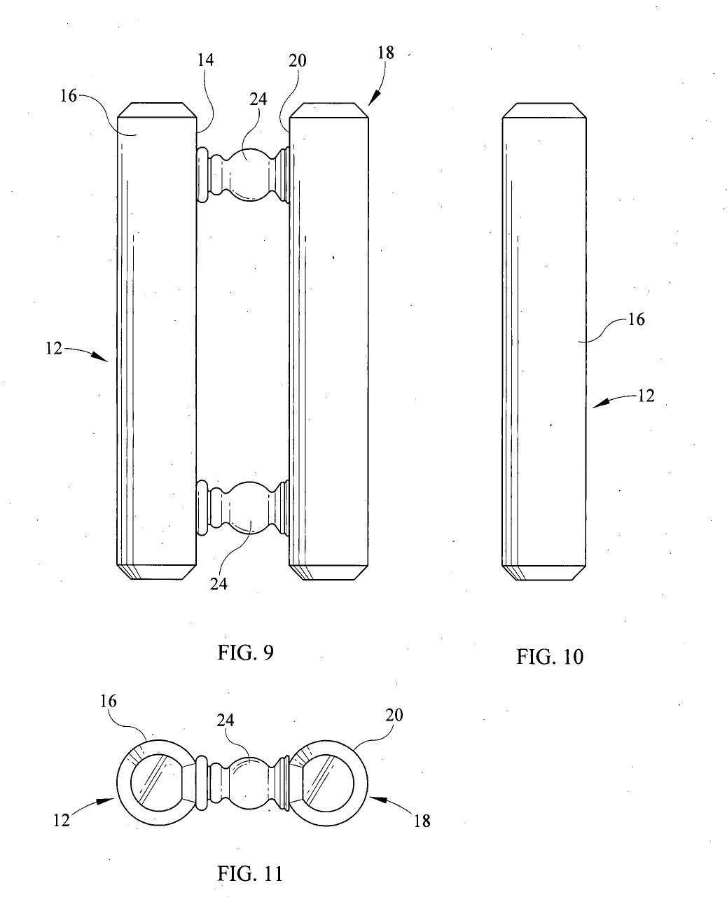

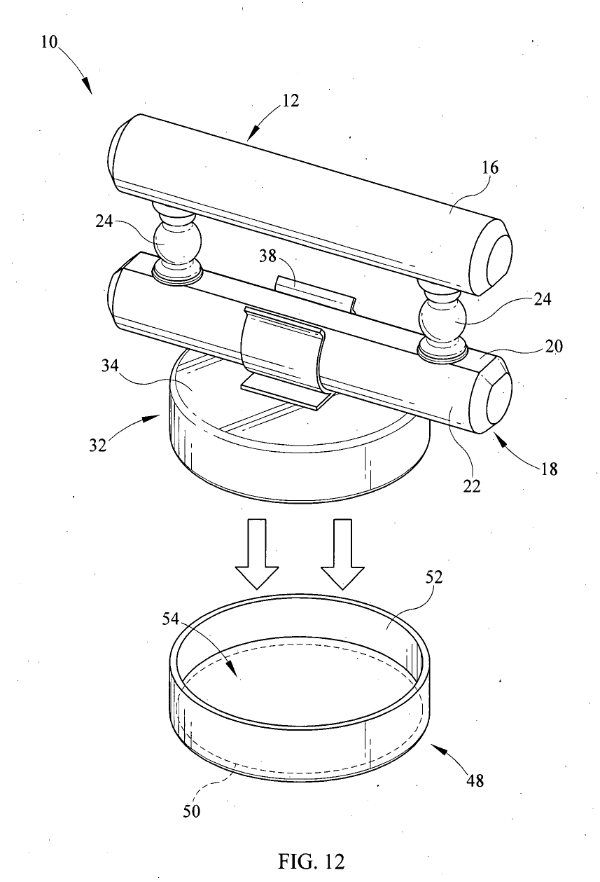

As seen in FIG. 3, one of the rollers 12 or 18 is used so that its rounded surface 16 or 22 respectively is pressed into a hot dog 26 receiving surface of a hot dog roll 28 so as to make an indent 30 thereinto, the length of the roller 12 or 18 used being slightly longer than a standard hot dog 26 so that the indent 30 so made snugly receives the hot dog 26. The other roller 18 or 12 acts as a handle for the user. The user grasps the handle 18 or 12 and places the opposing roller 12 or 18 onto the hot dog roll 28 and, using mainly wrist action, rolls radially across the hot dog roll 28 until the indent 30 is sufficiently wide to be able to receive the hot dog 26 therein. The hot dog 26 is now snugly seated in the indentation 30 made in the roll 28 and is much more stable during eating of same.

A hamburger press 32 is a relatively wide and short cylindrical member that has an upper surface 34 and a flat lower surface 36. A generally U-shaped resilient snap clip 38 is attached to the upper surface 34 of the hamburger press 32 by passing an appropriate screw 40 through the hamburger press 32 and the clip 38, the screw 40 being recessed within the lower surface 36. As seen, the hamburger press 32 is attached to one of the rollers 12 or 18 by snapping the respective roller 12 or 18 into the snap clip 38 which holds the hamburger press 32 thereat. Other attachment methods, such as passing a screw through one of the rollers 12 or 18 and the hamburger press 32, etc., can also be employed. The hamburger press 32 is attached to one of the rollers 12 or 18 and the other roller 18 or 12 is grasped by the user and pressed down, centrally onto a hamburger roll 42 so as to make an indent 44 therein. The indent 44 is slightly larger than a typical hamburger patty 46 so that the hamburger patty 46 fits snugly within the indentation 44 making the hamburger patty 46 much more stable during the eating of same (or a tomato or onion slice can be placed into the indent 44 in order to keep such items from sliding out during eating). The hamburger press 32 may be made from the same material as the rollers 12 and 18 and the connector legs 24, while the clip 38 is made from an appropriate resilient material such as plastic or metal.

As seen in FIG. 12, a patty press 48 is a hollow cylindrical member that has a flat bottom 50 and an upwardly depending sidewall 52 that define a hollow central portion 54, the sidewall 52 having an inside diameter that is substantially similar to the outside diameter of the hamburger press 32. An appropriate meat product, such as hamburger meat, case-less sausage meat, etc., is placed within the hollow central portion 54. Thereafter, the hamburger press 32 is positioned over the open top of the patty press 48 so that the hamburger press 32 is received within the hollow central portion 54 of the patty press 48 and presses onto the food product in order to form a patty.

Of course both the hamburger press 32 and the patty press 48 may be of another shape, such as square for different shaped hamburger patties.

While the invention has been particularly shown and described with reference to an embodiment thereof, it will be appreciated by those skilled in the art that various changes in form and detail may be made without departing from the spirit and scope of the invention.

I claim:

1. A utensil comprising:
a first elongated cylindrical roller having a first flattened portion;
a second elongated cylindrical roller having a second flattened portion;
a connector leg having a first end attached to the first flattened portion of the first roller and to the second flatten portion of the second roller; and
wherein the first roller is adapted to be rolled across a hot dog bun with the second roller serving as a handle.

2. The utensil as in claim 1 wherein the first roller and the second roller are identical.

3. The utensil as in claim 1 further comprising a first press having an upper surface and a flat lower surface such that the upper surface is removably attached to the first roller and the lower surface is adapted to be pressed onto a hamburger roll.

4. The utensil as in claim 3 wherein the first press is attached to the first roller by providing a snap clip on the upper surface of the first press, the snap clip removably receiving the first roller.

5. The utensil as in claim 3 wherein the first roller and the second roller are identical.

6. The utensil as in claim 3 wherein the first press is cylindrical in shape.

7. The utensil as in claim 3 further comprising a second press having a flat bottom and an upwardly depending sidewall defining a hollow central portion such that the hollow central portion receives the first press in order for the first press to press down into the hollow central portion to thereby shape a food product adapted to be held within the hollow central portion.

8. The utensil as in claim 7 wherein the first roller and the second roller are identical.

9. The utensil as in claim 7 wherein the first press and the hollow central portion are each cylindrical in shape.

10. The utensil as in claim 7 wherein the first press is attached to the first roller by providing a snap clip on the upper surface of the first press, the snap clip removably receiving the first roller.
